(19) United States
(12) Patent Application Publication
(10) Pub. No.: US 2010/0035496 A1
(43) Pub. Date: Feb. 11, 2010

(54) Method For Processing The Surface Of Polymer Substrates, Substrates Thus Obtained And Use Thereof In The Production Of Multilayered Materials

(75) Inventors: Panayotis Cocolios, Bullion (FR); Frederic Noel, Saint Jean de la Ruelle (FR)

Correspondence Address: AIR LIQUIDE;Intellectual Property, 2700 POST OAK BOULEVARD, SUITE 1800, HOUSTON, TX, 77056, US

(73) Assignee: L'Air Liquide Societe Anonyme Pour l'Etude Et l'Exploitation Des Procedes Georges Claude, Paris (FR)

(21) Appl. No.: 12/522,996

(22) PCT Filed: Oct. 26, 2007
(86) PCT No.: PCT/FR07/52252

§ 371 Date: Jul. 13, 2009

(30) Foreign Application Priority Data
Jan. 24, 2007 (FR) 0752849

(51) Int. Cl. B32B 27/02; H05H 1/24; B32B 37/06

(52) U.S. Cl. 442/164; 427/569; 156/155

(57) ABSTRACT

The invention relates to a method for processing the surface of polymer substrates, during which the substrate is subjected to a dielectric-barrier electric discharge of the filament type in a gaseous processing mixture containing at least a carrier gas and an active gas and under a pressure substantially equal to the atmospheric pressure, characterized in that the active gas is selected from the group including a mono-unsaturated or poly-unsaturated linear or branched hydrocarbon preferably containing 2 to 10 carbon atoms, more preferably 2 to 5 carbon atoms and even more preferably 2 or 3 carbon atoms, the residual oxygen content of the processing mixture being lower than 250 ppm, preferably lower than 100 ppm, and more preferably lower than 50 ppm.

The present invention relates to the field of surface treatments of polymer substrates, which are widely used in very many industries, especially those of food packaging or pharmaceutical packaging, graphic arts, manufacture of adhesive labels or tapes, furniture protection, floor mats, or thermal insulation, or else for manufacturing insulating electrical components.

It relates more particularly to the manufacture of printed or unprinted single-layer or multilayer materials used by these industries. Such materials must have a high surface energy that provides them with excellent wettability and very good adhesion during conversion operations such as printing or bonding, in which processes the wetting of the substrate and its adhesion to a coating (ink, adhesive, varnish, etc.) are absolutely essential. However usually these materials have surface properties that make them difficult to use in these conversion processes. Similarly, the difference in nature between the various materials used, plastic films or sheets of hydrophobic polyolefin type or other type, paper, aluminum foil leads to contacting difficulties which are only resolved by a specific preparation of the surface of the substrate.

Among the operations most widely used for carrying out this specific preparation that makes it possible to render the surface of the polymers “active”, there are in particular methods for the prior liquid coating of the surfaces with suitable bifunctional compounds known as “adhesion primers”, that provide, in particular, the adhesion between the layers of two different substrates or the adhesion of an ink or of a varnish to a substrate.

These techniques require the adhesion primers to be dissolved in polluting organic solvents at a concentration of around 20% solids. Their use therefore requires a consequent energy consumption in order to evaporate the solvent, then to recycle it or else incinerate it.

Therefore, other treatments have been developed, such as low-pressure plasma surface treatments, for the purpose of introducing onto the surface of the polymer chemical functionalities/groups such as amine, amide, nitrile or else carbonyl, carboxyl or other alcohol or ester groups, and thus changing the surface properties of the polymer, for example to give it a certain hydrophilicity or else to improve the adhesion with inks, varnishes or adhesives. This category of low-pressure treatments is especially described by N. Inagaki in the work “Plasma surface modification and plasma polymerization”, Laboratory of Polymer Chemistry at Shizuoka University, TECHNOMIC Publishing Co. Inc., published in 1996, and by document EP-679 680.

Despite them being very environmentally friendly, these low-pressure plasma methods have a major drawback linked to the fact that they are carried out at reduced pressure in batch mode, and are therefore incompatible with the treatment of large polymer surfaces at the high production rates that have to be used in continuous mode.

One alternative to these treatments is today widely used in industry. It is a surface treatment of a polymer substrate by electrical discharge in air at atmospheric pressure (commonly known as “corona treatment”).

However, such a treatment is not satisfactory. Specifically, not only are the surface energy values obtained by this treatment too low in the case of certain polymers such as polypropylene, but they also decrease rapidly over time (unsatisfactory aging).

The Applicant has therefore proposed, in documents WO 92/11321 and EP-622 474, a method for the surface treatment of polymer substrates during which the substrate is subjected to a dielectric barrier electrical discharge, in an atmosphere containing a carrier gas, a silane and an oxidizing gas, at a pressure substantially equal to atmospheric pressure, for the purpose of depositing a silicon-based layer on the surface of the substrate. As these documents indicate, the processes in question undoubtedly give rise to excellent surface properties, but it is recognized that the use of a silane introduces a further cost which is not always acceptable, especially for low added-value applications.

Finally, document WO 01/58992 A1 in the name of the Applicant describes a method for the surface treatment of polymer films and sheets during which the substrate is subjected to a dielectric barrier electrical discharge, in a gas mixture containing a carrier gas and also a reducing gas and/or an oxidizing gas, at a pressure substantially equal to atmospheric pressure.

This treatment has the effect of grafting nitrogen atoms to the surface of the substrate via covalent bonds in the form of amine, amide and imide functional groups. The variations of treatment gas mixtures make it possible to adjust the amount of nitrogen grafted to the surface of the substrate from 3 to 8%, which represents a conversion of only a portion of the surface exposed to the electrical discharge.

However, the use of the method according to WO 01/58992 A1 poses, for some applications, several specific problems which can be summarized thus:
firstly, it requires large and therefore expensive equipment. Specifically, since the ionization threshold of the gas mixtures used to create the plasma are high at a pressure substantially equal to atmospheric pressure, it is necessary to increase the number of electrodes in order to be able to transmit the necessary electrical power. In order to remain compatible with an economical industrial operation, it is therefore necessary to limit the treatment rate;
it is then also necessary to manage the problems linked to the cooling of the plant heated by the electrodes that operate at a high electric potential;
furthermore, heat-sensitive films (of the heat-shrinkable type) cannot be treated by such a process without being damaged by the heat released; and
finally, the high powers necessary for the implementation of this process are limited by the size of conventional generators, therefore limiting the range of families of materials that can be treated.

The huge interest that there would be in having a novel process that makes it possible to solve the difficulties that the last process mentioned poses as regards the treatment of certain materials can then be understood:
it would then be most particularly advantageous to be able to provide a novel process that makes it possible to treat a wider range of materials, especially heat-sensitive films;
it is advisable to improve the process so as to reduce the specific energy necessary for the treatment of the surfaces, and thus to reduce the investment costs; and
it is also advisable that this novel process makes it possible to achieve high treatment rates of the same order as that of modern equipment for the conversion or printing of plastic films, for example typically ranging from 300 to 600 m/min.

As will be seen in greater detail in what follows, the present inventors have highlighted that a solution to these problems was able to be provided by using, in a dielectric barrier electrical discharge process of filamentary type, at a pressure substantially equal to atmospheric pressure, a treatment atmosphere comprising a carrier gas, and also one particular active gas, in the absence of oxygen or in any case in the presence of an extremely reduced residual oxygen content.

According to the present invention the expression “pressure substantially equal to atmospheric pressure” is understood to mean the fact that it is possible, without departing from the scope of the present invention, to work at pressures that lie at a few tens of millibars, or even a few hundreds of millibars around atmospheric pressure. But it should be noted that it will be preferred to be located in a range of ±200 Pa around atmospheric pressure, and more preferably still in a range of ±25 Pa around this atmospheric pressure.

Thus, the present invention relates to a surface treatment method (it can also be referred to as a “surface functionalization method” without at any point departing from the scope of the present invention) for polymer substrates (whether they are synthetic or natural polymers), during which the substrate is subjected to a dielectric barrier electrical discharge of filamentary type, in a treatment gas mixture containing at least one carrier gas and one active gas, at a pressure substantially equal to atmospheric pressure, characterized in that the active gas is chosen from the group comprising at least one linear or branched, monounsaturated or polyunsaturated hydrocarbon preferably having 2 to 10 carbon atoms, more preferably 2 to 5 carbon atoms, more preferably still 2 or 3 carbon atoms, optionally substituted by at least one functional group of the amine, amide, acid, alcohol, imine, imide, or halide type, or by at least one coupling agent especially by silanol groups, and combinations thereof, the residual oxygen content of the treatment mixture being less than 250 ppm, preferably less than 100 ppm, and more preferably still less than 50 ppm.

By way of clarification, generally a “coupling agent” refers to a bifunctional molecule that makes it possible to “couple” or “bridge” two macromolecules or two surfaces via chemical reactions between the functional groups of the “coupling agent” and the two surfaces in question (to put it another way like concrete pillars that “interconnect” two stories of a building).

It is then possible to use, according to the present invention, by way of illustration, a complex molecule containing both chlorides and silanol groups.

Preferably, the active gas is a gas or a liquid in equilibrium with its vapor and for which the vapor pressure at a temperature of 20° C. is greater than 10 Pascal.

Preferably, the active gas is chosen from unsaturated hydrocarbons having 1, 2 or 3 carbon atoms. More preferably, the active gas is acetylene or ethylene or propylene, or a mixture of these gases.

Without wishing to be tied to any one theory, the inventors believe that the active gas which is a gaseous molecule or a liquid molecule in the vapor state that has a low ionization threshold and a very high chemical reactivity via a radical mechanism simultaneously enables a high increase in the percentage of nitrogen grafted to the substrate, a significant decrease in the specific power necessary for implementing the method, and therefore an increase in the diversity of the polymer substrates that are compatible with said method according to the invention.

More specifically, it may be believed that the good results obtained according to the present invention, which will be presented below, must be attributed to the use of the combined and synergistic means according to the present invention, namely the type of discharge chosen, the type of active gas present, and the absence of oxygen in the treatment atmosphere.

Oxygen is a particularly reactive gas when it is subjected to a source of energy, it is in fact easily excitable. In the presence of O₂, even having very low contents, the competition between O₂ and N₂ is in favor of oxygen. In the case of the present invention, using a hydrocarbon for example acetylene, working in the presence of oxygen would result in the preferential reaction between O₂ and C₂H₂.

It is therefore essential to limit the oxygen content to a minimum value so that a large part of the hydrocarbon injected does not react with the oxygen and thus does not mask the effects of this hydrocarbon on the surface treatment.

It is also possible to put forward the hypothesis that the oxygen molecule, besides the fact that it has a very low excitation threshold and is very easily excited leading to the formation of metastable species, ions and radicals that are very reactive and oxidize the polymer, recombinations are witnessed with oxygen in order to form ozone which, in turn, strongly degrades the polymer via oxidation. It may also be believed that the oxygen molecule reacts very rapidly with the radicals formed by excitation of the active gas in the gas phase and thus blocks the development of the reaction mechanism that leads to the grafting reactions.

One carrier gas particularly suitable for the implementation of the invention is nitrogen, but a person skilled in the art is able to choose another carrier gas, especially argon, helium or a mixture of these gases with one another and/or with nitrogen. The invention should not however be limited to these gases, since a person skilled in the art is qualified to substitute these gases by any other gas that allows an implementation of the invention.

In one embodiment of the invention, the method is characterized in that the treatment gas mixture also comprises an additional reducing gas and/or an oxidizing gas (reference is made here to an “additional” reducing gas in order to introduce the greatest clarity possible since, as is known, hydrocarbons such as acetylene are generally considered to be reducing gases). Preferably, hydrogen is chosen as the reducing gas and the oxidizing gas is chosen from CO₂, NO, and H₂O or a mixture of these gases. A person skilled in the art is of course able to choose another reducing or oxidizing gas suitable for the invention.

Thus, one particularly preferred subject of the present invention is a method for the surface treatment of polymer substrates as described above, in which said treatment gas mixture is an N₂/H₂, N₂/CO₂ or N₂/N₂O mixture in combination with an active gas according to the invention. Preferably, the active gas chosen is acetylene and the treatment mixture is then preferably one of the following combinations:

N₂/C₂H₂, N₂/H₂/C₂H₂, N₂/CO₂/C₂H₂, or N₂/N₂O/C₂H₂.

For the implementation of the invention, the contents of the active gas and the reducing and/or oxidizing gas are preferably adjusted so as to obtain a surface energy of the thus treated substrates that is greater than or equal to around 60 mN/m. A surface energy of around 60 mN/m corresponds to a wettability commonly accepted as being satisfactory by a person skilled in the art.

In particular, the content of active gas in the mixture is within a range going from 50 to 1000 ppm vol., preferably from 100 to 600 ppm vol., and more preferably still in the vicinity of 300 ppm vol.

Similarly, the content of reducing gas or of oxidizing gas in the mixture is advantageously within a range going from 50 to 3000 ppm vol, preferably from 100 to 1500 ppm vol, more preferably from 250 to 1000 ppm vol.

In another embodiment of the invention, the substrate is first subjected to a pretreatment by passing into a dielectric barrier electrical discharge at a pressure substantially equal to atmospheric pressure in a pretreatment gas mixture composed of air or of an inert gas or of a mixture of these gases. The inert gas is of the same nature as or of a different nature to the carrier gas according to the invention and is especially chosen from nitrogen, argon, helium or a mixture of these gases.

In accordance with the invention, the polymer substrate is preferably macroscopically flat, and is then in the form of a sheet, a film or a foam. The substrate is in addition preferably composed of woven or non-woven polymer fibers.

In particular, the polymer substrate is especially chosen from:
a synthetic polymer chosen from a polyamide, polyvinyl chloride, polyester, polyethylene, polypropylene, polystyrene, polycarbonate, polyvinyl alcohol, polyvinyl dichloride or a polyvinyl acetate, or else a fluoropolymer such as polytetrafluoroethylene;
a synthetic or natural rubber;
a biodegradable polymer especially chosen from polylactic acid (PLA), polycaprolactone (PCL) and starch-based polymers.

This list of polymers above is given only by way of illustration and is in no way limiting.

Polymer substrates according to the invention are also any multilayer films comprising at least one of the polymers from the aforementioned list.

Another subject of the present invention is any polymer substrate characterized in that it is treated by the method according to the invention.

Preferably, the polymer substrate treated according to the invention is macroscopically flat and has the shape of a sheet, a film or a foam. The polymer substrate may, in addition, be composed of woven or non-woven polymer fibers.

More preferably still, the polymer treated by the method of the invention is chosen from:
a synthetic polymer chosen from a polyamide, polyvinyl chloride, polyester, polyethylene, polypropylene, polystyrene, polycarbonate, polyvinyl alcohol, polyvinyl dichloride or a polyvinyl acetate, or else a fluoropolymer such as polytetrafluoroethylene;
a synthetic or natural rubber;
a biodegradable polymer especially chosen from polylactic acid (PLA), polycaprolactone (PCL) and starch-based polymers.

This list of polymers above is given only by way of illustration and is no way limiting.

The method for the surface treatment of polymer substrates of the present invention also makes it possible to solve a supplementary technical problem not yet tackled to date.

Specifically, the adhesion between two surfaces is generally achieved via the coating of a glue (adhesive) on one or the other of the surfaces, or on both of them. These adhesives use chemicals that, during the final use of the product, are capable of migrating in contact with or into a food product for example. It is understood then that the elimination of such adhesives would be most particularly advantageous both for economical reasons (investment, operating costs, solvent recovery) and for health reasons.

Thus, one supplementary technical problem to which the present invention proposes to address is the achievement of an adhesion between two surfaces without the use of adhesive, via grafting, to each surface of molecules that react chemically with each other, the product of the reactions providing the cohesion between the two surfaces.

An additional subject of the present invention is therefore the use of polymer substrates treated according to the method of the invention for achieving adhesion of two surfaces without using adhesive.

In one embodiment, the adhesion between two surfaces according to the invention comprises the bringing into contact of two surfaces, the first surface being a surface of a polymer substrate treated according to the method of the invention, that is to say grafted with basic functional groups, and the second surface being a surface of a substrate capable of interacting with said first surface.

In one particular embodiment, said second surface is treated by a conventional method of the “corona” type as described in the prior art, generating the grafting of molecules that in the main are acidic to the surface to be treated. Thus, during the bringing into contact of the two grafted surfaces, the grafted functionalities are capable of reacting with one another and, in fact, of generating the adhesion between the two faces in the absence of glue or adhesive.

This embodiment may be applied to other known methods of promoting adherence between two surfaces. For example, extrusion-coating, in which the surface onto which the molten resin will be coated is a surface of a polymer substrate pretreated by the method according to the invention, whereas the film of molten resin undergoes an oxidation reaction via the molecular oxygen present in the air or better still via ozone produced by an ozonizer which generates oxygen-containing functional groups having an acid nature at the surface. Extrusion-lamination corresponds to assembling two substrates using molten resin as an adhesive which is coated simultaneously on one surface of each of the two substrates. More specifically, two surfaces are then treated according to the method of the invention and brought into contact via a film of molten resin, the two faces of which are treated with molecular oxygen or else with ozone.

Other variants compatible with the present invention are the high-temperature laminating or coating techniques, the adhesive laminating technique or else the thermal laminating technique that are known furthermore by a person skilled in the art.

The numerous advantages provided by the present invention will be better understood in light of the figures and examples that illustrate the description.

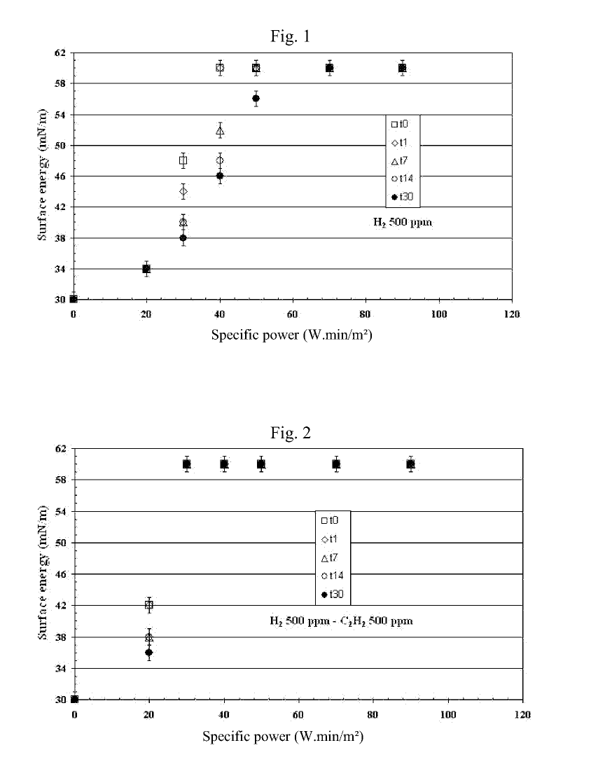

FIG. 1 is a graph representing, on the one hand, the change in the surface energy of a BOPP (biaxially-oriented polypropylene) film having a thickness of 20 μm following a treatment with the N₂/H₂ mixture (500 ppm of H₂) as a function of the specific power applied and, on the other hand, the stability of the treatment over a period of 30 days.

FIG. 2 is a graph representing, on the one hand, the change in the surface energy of a BOPP film having a thickness of 20 μm following a treatment according to the invention with the N₂/H₂/C₂H₂ mixture (500 ppm of H₂, 500 ppm of C₂H₂) as a function of the specific power applied and, on the other hand, the stability of the treatment over a period of 30 days.

### EXAMPLE 1

In a dielectric barrier electrical discharge device of the same type as that described by the Applicant in document WO 02/40738 A2 electrical discharges were applied to various biaxially-oriented polypropylene (BOPP) films having a thickness of 20 μm and a width varying from 200 to 2000 mm, at the rate of 75 m/min under the following conditions.

### Test 1: N₂/H₂ (500 ppm of H₂).

Test 2: N₂/H₂ (500 ppm of H₂)+500 ppm of acetylene C₂H₂.

For each test, different specific powers were applied, ranging from 20 W.min/m² to 100 W.min/m².

The surface energy of the treated films thus obtained was then measured, just after the treatment and 1, 7, 14 and 30 days after the treatment by applying calibrated inks according to the DIN ISO 8296 and ASTM D 2578-99a standards.

The results are shown in FIG. 1.

It emerges from these results that:
for test 1, a surface energy of 60 mN/m that was stable over 30 days at least (t30) was obtained provided that a specific power of at least 70 W.min/m² was applied; and
for test 2, a surface energy of 60 mN/m that was stable over 30 days at least was obtained this time from the application of a specific power of only 30 W.min/m², i.e. a specific power 2.5 times lower than that of test No. 1.

Thus, for a given treatment rate, with the method according to the invention, equipment of smaller size could be used to obtain a satisfactory surface energy of the polymer substrates.

Similarly, for a given equipment size, the treatment of the polymer substrates could be carried out with a rate 2.5 times higher.

Finally, the thermal effects linked to the heating of the electrodes following the application of high specific powers will be reduced, and thus heat-sensitive films will be able to be treated by the method according to the invention.

### EXAMPLE 2

In a device identical to that of example 1, various films of biaxially-oriented polypropylene (BOPP) having a thickness of 20 μm were treated with various discharges under the conditions:

### Test 3: N₂/H₂ (500 ppm of H₂)

### Test 4: N₂/H₂ (500 ppm of H₂)+50 ppm of C₂H₂

### Test 5: N₂/H₂ (500 ppm of H₂)+100 ppm of C₂H₂

### Test 6: N₂/H₂ (500 ppm of H₂)+500 ppm of C₂H₂

Test 7: N₂/CO₂ (500 ppm)
Test 8: N₂/CO₂ (500 ppm)+50 ppm of C₂H₂
Test 9: N₂/CO₂ (500 ppm)+100 ppm of C₂H₂
Test 10: N₂/CO₂ (500 ppm)+500 ppm of C₂H₂

For each test, different specific powers were applied, ranging from 20 W.min/m² to 100 W.min/m².

The surface energy of the treated films thus obtained was then measured as in example 1 above, and the specific power necessary to obtain a surface energy of 60 mN/m was revealed. The most significant values are presented in table 1 below:

TABLE 1

| | Specific power |
|---|---|
| Test | (W · min/m²) |
| 3 | 70 |
| 4 | 50 |
| 5 | 50 |
| 6 | 30 |
| 7 | 70 |
| 8 | 70 |
| 9 | 50 |
| 10 | 40 |

The results from table 1 clearly show that the addition, even in a minute amount (from 50 ppm for an N₂/H₂/C₂H₂ mixture), of acetylene in the mixture of reactive gases enables a very significant reduction in the specific power to be applied to the system. In addition, this reduction is observed whatever the gas mixture used, a ternary N₂/H₂/C₂H₂ mixture or a ternary N₂/CO₂/C₂H₂ mixture.

This reduction in the power to be applied to the system in order to carry out the surface treatment according to the invention allows thick materials, of the type of rigid polypropylene sheets or materials that are difficult to treat by atmospheric plasmas such as polytetrafluoroethylene, PTFE, that until now required large amounts of energy to be supplied, to be treated at a lower cost which constitutes another advantage of the present invention.

### EXAMPLE 3

A BOPP substrate having a thickness of 20 μm was treated in a device identical to the device from example 1 with an atmosphere of a ternary N₂/H₂/C₂H₂ mixture (500 ppm H₂ and 500 ppm C₂H₂) while varying the specific power applied.

For each test, the chemical composition of the treated surface was analyzed by ESCA spectroscopy (electron spectroscopy for chemical analysis). In each case the surface energy, measured as described in example 1, was 60 mN/m and stable to 30 days.

Table 2 below collates the results obtained.

TABLE 2

| Specific | | Angle of | | | | |
|---|---|---|---|---|---|---|
| power | H₂/C₂H₂ | analysis | | | | |
| (W · min/m²) | (ppm/ppm) | (°) | % C | % O | % N | N/O |
| 70 | 500/0 | 0 | 91.77 | 3.34 | 4.89 | 1.46 |
| | | 75 | 85.84 | 5.84 | 8.32 | 1.42 |
| 30 | 500/500 | 0 | 90.48 | 3.45 | 6.07 | 1.76 |
| | | 75 | 85.60 | 5.19 | 9.21 | 1.77 |
| 50 | 500/500 | 0 | 91.39 | 3.15 | 5.46 | 1.73 |
| | | 75 | 86.52 | 4.95 | 8.53 | 1.72 |
| 70 | 500/500 | 0 | 85.29 | 4.35 | 10.36 | 2.38 |
| | | 75 | 79.87 | 6.23 | 13.90 | 2.23 |

The results displayed in table 2 above firstly show that at an equivalent fixed level of nitrogen, 70 W.min/m² are consumed for an N₂/H₂ mixture and only 30 W.min/m² are consumed for an N₂/H₂/C₂H₂ mixture.

Secondly, the more the specific power supplied to the system increases, the more the amount of grafted nitrogen increases, as does the value of the N/O ratio which approaches 2.5.

Thirdly, for one and the same applied specific power of 70 W.min/m², 70% more nitrogen is grafted with a ternary N₂/H₂/C₂H₂ mixture, compared to the binary N₂/H₂ mixture.

Finally, an attachment of nearly 14% nitrogen to the surface of the BOPP is achieved for a treatment with a ternary N₂/H₂/C₂H₂ mixture and an applied specific power of 70 W.min/m², against only 8.3% for the conventional treatment, i.e. an increase of around 75% of the number of nitrogen atoms grafted.

It thus emerges from the various implementation examples of the method according to the present invention that this method is effectively better performing than the methods of the prior art. Specifically, the method of the invention makes it possible, simultaneously, to increase the reactivity of the gas mixture, to increase the percentage of nitrogen grafted to the substrate, to significantly reduce the specific power necessary for the implementation of the method, and finally to increase the diversity of the polymer substrates compatible with said method according to the invention.

1-25. (canceled)

26. A method for the surface treatment of polymer substrates during which the substrate is subjected to a dielectric barrier electrical discharge of filamentary type, in a treatment gas mixture containing at least one carrier gas and one active gas, at a pressure substantially equal to atmospheric pressure, wherein the active gas is chosen from the group comprising at least one linear or branched, monounsaturated or polyunsaturated hydrocarbon, the residual oxygen content of the treatment mixture being less than 250 ppm.

27. The method of claim 26, wherein the hydrocarbon comprises from having 2 to 10 carbon atoms.

28. The method of claim 27, wherein the residual oxygen content of the treatment mixture is less than 100 ppm.

29. The method of claim 26, wherein the hydrocarbon is substituted by at least one functional group selected from amine, amide, acid, alcohol, imine, imide or halide groups, or by at least one coupling agent, or a combination thereof.

30. The method of claim 29, wherein the at least one coupling agent is selected from silanol groups.

31. The method of claim 26, wherein the active gas is a gas or a liquid in vapor state for which the vapor pressure at a temperature of 20° C. is greater than 10 Pascal.

32. The method of claim 26, wherein the active gas is chosen from unsaturated hydrocarbons having 2 or 3 carbon atoms.

33. The method of claim 26, wherein the active gas is acetylene or ethylene or propylene, or a mixture of these gases.

34. The method of claim 26, wherein the treatment gas mixture also comprises an additional reducing gas, an additional oxidizing gas or both an additional reducing gas and an additional oxidizing gas.

35. The method of claim 34, wherein the additional reducing gas is hydrogen.

36. The method of claim 34, wherein the oxidizing gas is chosen from CO₂, NO₂ and H₂O or a mixture of these gases.

37. The method of claim 26, wherein the content of active gas in the mixture is within a range of from 50 to 1000 ppm vol.

38. The method of claim 34, wherein the content of additional reducing gas or the content of oxidizing gas is within a range of from 50 to 3000 ppm vol.

39. The method of claim 29, wherein the substrate has been subjected to a pretreatment by passing into a dielectric barrier electrical discharge at a pressure substantially equal to atmospheric pressure in a pretreatment gas mixture composed of air or of an inert gas or of a mixture of these gases.

40. The method of claim 39, wherein the carrier gas and/or inert gas are identical or different and are chosen from nitrogen, argon, helium or a mixture of these gases.

41. The method of claim 26, wherein the substrate is macroscopically flat and has the shape of a sheet, a film or a foam.

42. The method of claim 26, wherein the substrate is composed of woven or non-woven polymer fibers.

43. The method of claim 26, wherein the polymer is chosen from:
a. a synthetic polymer chosen from a polyamide, polyvinyl chloride, polyester, polyethylene, polypropylene, polystyrene, polycarbonate, polyvinyl alcohol, polyvinyl dichloride or a polyvinyl acetate, or else a fluoropolymer such as polytetrafluoroethylene; or
b. a synthetic or natural rubber; or
c. a biodegradable polymer especially chosen from polylactic acid (PLA), polycaprolactone (PCL) and starch-based polymers.

44. A polymer substrate comprising a polymer that is chosen from:
a. a synthetic polymer chosen from a polyamide, polyvinyl chloride, polyester, polyethylene, polypropylene, polystyrene, polycarbonate, polyvinyl alcohol, polyvinyl dichloride or a polyvinyl acetate, or else a fluoropolymer such as polytetrafluoroethylene; or
b. a synthetic or natural rubber; or
c. a biodegradable polymer especially chosen from polylactic acid (PLA), polycaprolactone (PCL) and starch-based polymers.
that is subjected to a surface treatment comprising subjecting the polymer substrate to a dielectric barrier electrical discharge of filamentary type, in a treatment gas mixture containing at least one carrier gas and one active gas, at a pressure substantially equal to atmospheric pressure, wherein the active gas is chosen from the group comprising at least one linear or branched, monounsaturated or polyunsaturated hydrocarbon having from 2 to 10 carbon atoms, the residual oxygen content of the treatment mixture being less than 250 ppm.

45. The polymer substrate of claim 44, wherein the polymer substrate is macroscopically flat and has the shape of a sheet, film or foam.

46. The polymer substrate of claim 44, wherein the polymer substrate is composed of woven or non-woven polymer fibers.

47. The polymer substrate of claim 45, wherein the polymer substrate is composed of woven or non-woven polymer fibers.

48. A method for achieving the adhesion of two surfaces without the use of adhesive, the method comprising contacting a first surface with a second surface, the first surface comprising a polymer substrate that has been subjected to a surface treatment that comprises subjecting the polymer substrate to a dielectric barrier electrical discharge of filamentary type, in a treatment gas mixture containing at least one carrier gas and one active gas, at a pressure substantially equal to atmospheric pressure, the active gas being selected from the group comprising at least one linear or branched, monounsaturated or polyunsaturated hydrocarbon having from 2 to 10 carbon atoms and the residual oxygen content of the treatment mixture being less than 250 ppm and the second surface being a surface of a substrate that is capable of interacting with the first surface.

49. The method of claim 48, wherein the second surface is a surface of a substrate treated by a method of the air corona type.

50. The method of claim 48, wherein the first surface is brought into contact with a molten resin that has undergone an oxidation via oxygen or ozone.

51. The method of claim 48, wherein the first surface and second surface are brought into contact using a layer of molten resin treated on each of these two faces by oxidation via oxygen or ozone.

52. The method of claim 48, wherein the method is used for implementing high-temperature laminating or coating techniques, adhesive laminating techniques or thermal laminating techniques.
